(19) United States
(12) Patent Application Publication
(10) Pub. No.: US 2020/0024839 A1
(43) Pub. Date: Jan. 23, 2020

(54) SANITARY PLUNGER WITH A CHECK VALVE

(71) Applicant: Anthony Tapper, Papillion, NE (US)

(72) Inventor: Anthony Tapper, Papillion, NE (US)

(21) Appl. No.: 16/516,719

(22) Filed: Jul. 19, 2019

Related U.S. Application Data
(60) Provisional application No. 62/701,754, filed on Jul. 21, 2018.

(51) Int. Cl. E03D 9/00; F16K 15/00

(52) U.S. Cl. CPC E03D 9/00; F16K 15/00

(57) ABSTRACT

A sanitary plunger with a check valve. Further, the sanitary plunger may include a handle. Further, the handle may include an elongated cylindrical structure configured for handling the sanitary plunger, and manipulation of a plunger head. Further, the handle may include a coupling mechanism at first end of the elongated cylindrical structure. Further, the coupling mechanism may be configured for interfacing with the plunger head. Further, the handle may include a check valve configured for allowing one directional flow of fluids from the plunger head to the handle. Further, the sanitary plunger may include the plunger head including a generally hemispherical shape. Further, the plunger head may be configured for clearing clog build-up inside a drain channel. Further, the plunger head may include a central elongation from a top end of the plunger head. Further, the central elongation may include an opening configured for receiving the coupling mechanism of the handle.

### RELATED APPLICATION(S)

Under provisions of 35 U.S.C. § 119e, the Applicant(s) claim the benefit of U.S. provisional application No. 62/701,754 filed on Jul. 21, 2018, which is incorporated herein by reference.

### FIELD OF THE INVENTION

The disclosure relates generally to sanitary equipment, and in particular to a sanitary plunger with a check valve.

### BACKGROUND OF THE INVENTION

For millions of homeowners, clearing a toilet clog is always unpleasant and can be very messy, particularly when the water level is high in the toilet. Large air bubbles, released when the plunger is compressed, can cause fouled toilet water to spill over the rim. Also, some users may not have the arm strength needed to create the necessary pressure. The plunger when compressed puts no pressure on clogged toilet and by doing this, an optimal seal is achieved when pulling back to release clog allowing water to flow around clog and pulling it down the pipe instantly. A plunger which is easier to use, that never pushes and always pulls with vents in shaft to allow pressure against debris to escape with no agitation to water would be useful and would be well received.

Therefore, there is a need for an improved sanitary plunger with a check valve that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a sanitary plunger with a check valve is disclosed. Further, the sanitary plunger may include a handle. Further, the handle may include an elongated cylindrical structure configured for handling the sanitary plunger, and manipulation of a plunger head. Further, the handle may include a coupling mechanism at first end of the elongated cylindrical structure. Further, the coupling mechanism may be configured for interfacing with the plunger head. Further, the handle may include at least one air vent proximate to the first end configured to vent air pressure from the plunger head. Further, the handle may include a check valve configured for allowing one directional flow of fluids from the plunger head to the handle. Further, the sanitary plunger may include the plunger head including a generally hemispherical shape. Further, the plunger head may be configured for clearing clog build-up inside a drain channel. Further, the plunger head may include a central elongation from a top end of the plunger head. Further, the central elongation may include an opening configured for receiving the coupling mechanism of the handle.

Further, according to some embodiments, a sanitary plunger with a check valve. Further, the sanitary plunger may include a handle. Further, the handle may include an elongated cylindrical structure configured for handling the sanitary plunger, and manipulation of a plunger head. Further, the handle may include a plurality of threads configured for interfacing with the plunger head at a first end of the elongated cylindrical structure. Further, the handle may include at least one air vent proximate to the first end configured to vent air pressure from the plunger head. Further, the handle may include a screened check valve configured for allowing one directional flow of fluids from the plunger head to the handle. Further, the sanitary plunger may include the plunger head including a generally hemispherical shape. Further, the plunger head may be configured for clearing clog build-up inside a drain channel. Further, the plunger head may include a central elongation from a top end of the plunger head. Further, the central elongation may include an opening including a plurality of receiving threads configured for receiving the plurality of threads of the handle.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side view of a sanitary plunger, in accordance with some embodiments.

FIG. 2 is a top perspective view of a sanitary plunger, in accordance with some embodiments.

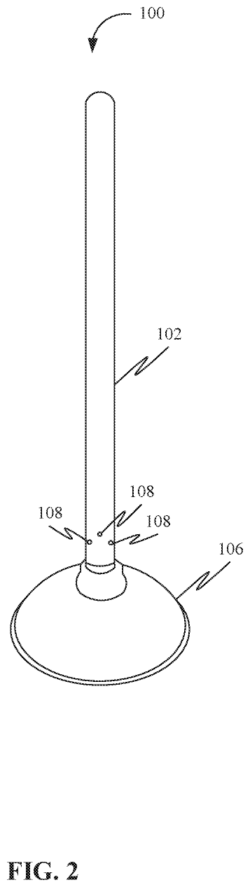

FIG. 3 is a bottom perspective view of a sanitary plunger, in accordance with some embodiments.

FIG. 4 is a side view of a sanitary plunger, in accordance with some embodiments.

FIG. 5 is a top perspective view of a sanitary plunger, in accordance with some embodiments.

FIG. 6 is a bottom perspective view of a sanitary plunger, in accordance with some embodiments.

FIG. 7 is a side close-up partial view of a sanitary plunger, in accordance with some embodiments.

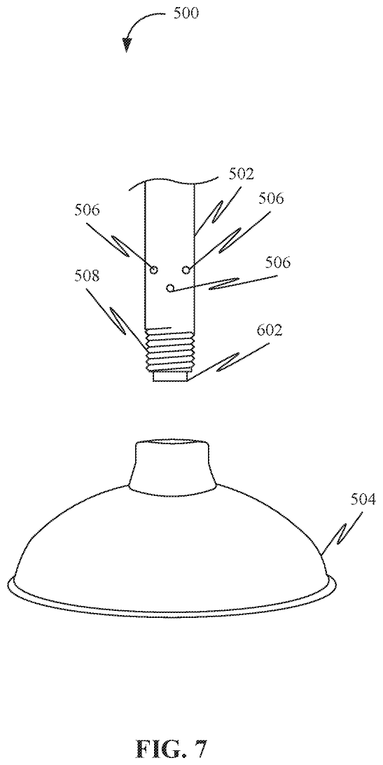

FIG. 8 is a bottom perspective close-up partial view of a sanitary plunger, in accordance with some embodiments.

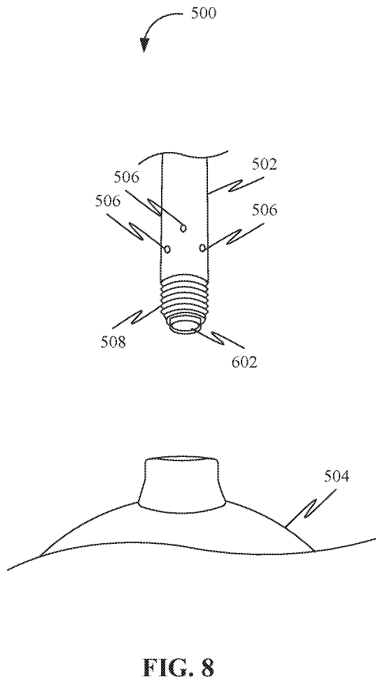

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a sanitary plunger with a check valve, embodiments of the present disclosure are not limited to use only in this context.

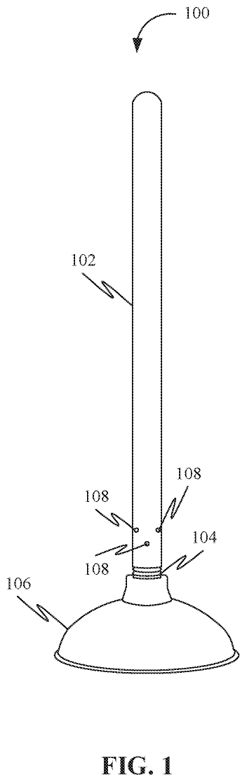

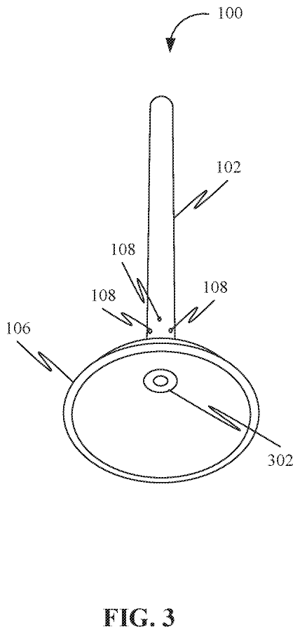

FIG. 1 is a sanitary plunger 100 with a check valve, in accordance with some embodiments. Further, the sanitary plunger 100 may include a handle 102. Further, the handle 102 may include an elongated cylindrical structure configured for handling the sanitary plunger 100, and manipulation of a plunger head 106. Further, the handle 102 may include a coupling mechanism 104 at first end of the elongated cylindrical structure. Further, the coupling mechanism 104 may be configured for interfacing with the plunger head 106. Further, the handle 102 may include at least one air vent 108 proximate to the first end configured to vent air pressure from the plunger head 106. Further, the handle 102 may include a check valve 302, as shown in FIG. 3, configured for allowing one directional flow of fluids from the plunger head 106 to the handle 102. Further, the sanitary plunger 100 may include the plunger head 106 including a generally hemispherical shape. Further, the plunger head 106 may be configured for clearing clog build-up inside a drain channel Further, the plunger head 106 may include a central elongation from a top end of the plunger head 106. Further, the central elongation may include an opening configured for receiving the coupling mechanism 104 of the handle 102.

Further, in some embodiments, the check valve 302 may include at least one of a ball check valve, a diaphragm check valve, a spring check valve, a stop check valve, and a lift check valve.

Further, in some embodiments, the check valve 302 may include a screened check valve.

Further, in some embodiments, the check valve 302 and the at least one air vent 108 may be configured for creating a one-way flow of fluids enabling build-up of suction for clearing the clog build-up inside the drain channel

Further, in some embodiments, the handle 102 may be manufactured from a rigid and durable material including at least one of wood, plastic, and fiberglass.

Further, in some embodiments, the check valve 302 may be manufactured from a rigid, durable, and corrosion resistant material including at least one of steel, brass, plastic, and aluminum alloy.

Further, in some embodiments, the plunger head 106 may be manufactured from a flexible and durable material including at least one of Polychloroprene, Styrene-Butadiene-Rubber, and Polychloroprene.

Further, in some embodiments, the plunger head 106 may be resiliently collapsible. Further, a shape of the plunger head 106 may be configured to adapt based on a shape of the drain.

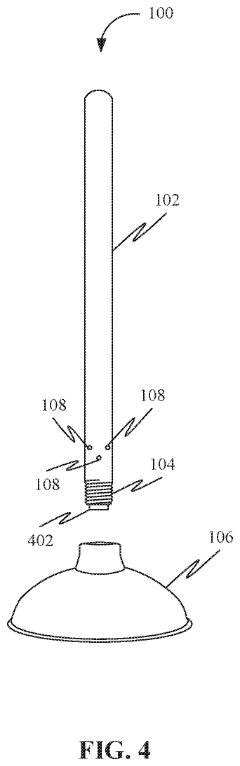

Further, in some embodiments, the coupling mechanism 104 may include a plurality of threads 402, as shown in FIG. 4, configured for interfacing with the plunger head 106.

Further, in some embodiments, Further, the opening may include a plurality of receiving threads (not shown) configured for receiving the plurality of threads 402.

Further, in some embodiments, the plunger head 106 may include a vent bore extending from an outer surface of the plunger head 106 to an inner surface of the plunger head 106. Further, in some embodiments, the plunger head 106 include a vent valve assembly disposed in the vent bore.

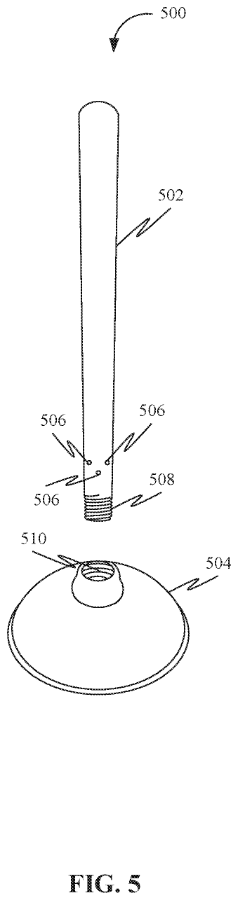

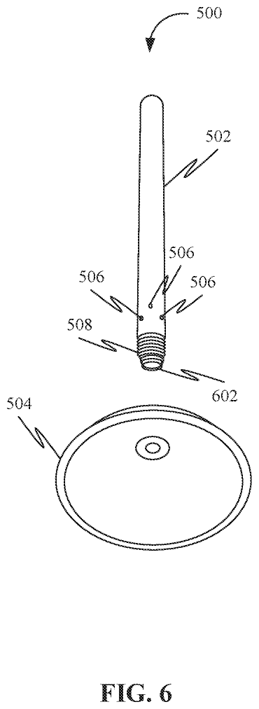

FIG. 5 is a sanitary plunger 500 with a check valve, in accordance with some embodiments. Further, the sanitary plunger 500 may include a handle 502. Further, the handle 502 may include an elongated cylindrical structure configured for handling the sanitary plunger 500, and manipulation of a plunger head 504. Further, the handle 502 may include a plurality of threads 508 configured for interfacing with the plunger head 504 at a first end of the elongated cylindrical structure. Further, the handle 502 may include at least one air vent 506 proximate to the first end configured to vent air pressure from the handle 502. Further, the handle 502 may include a screened check valve 602, as shown in FIG. 6 configured for allowing one directional flow of fluids from the plunger head 504 to the handle 502. Further, the sanitary plunger 500 may include the plunger head 504 including a generally hemispherical shape. Further, the plunger head 504 may be configured for clearing clog build-up inside a drain channel. Further, the plunger head 504 may include a central elongation from a top end of the plunger head 504. Further, the central elongation may include an opening including a plurality of receiving threads 510 configured for receiving the plurality of threads 508 of the handle 502.

Further, in some embodiments, the screened check valve 602 may include at least one of a ball check valve, a diaphragm check valve, a spring check valve, a stop check valve, and a lift check valve.

Further, in some embodiments, the handle 502 may be manufactured from a rigid and durable material including at least one of wood, plastic, and fiberglass.

Further, in some embodiments, Further, the check valve may be manufactured from a rigid, durable, and corrosion resistant material including at least one of steel, brass, plastic, and aluminum alloy.

Further, in some embodiments, the plunger head 504 may be manufactured from a flexible and durable material including at least one of Polychloroprene, Styrene-Butadiene-Rubber, and Polychloroprene.

Further, in some embodiments, the plunger head 504 may be resiliently collapsible. Further, a shape of the plunger head 504 may be configured to adapt based on a shape of the drain.

Further, in some embodiments, the plunger head 504 may include a vent bore extending from an outer surface of the plunger head 504 to an inner surface of the plunger head 504.

Further, in some embodiments, the plunger head 504 may include a vent valve assembly disposed in the vent bore.

Further, according to some embodiments, a toilet plunger, such as the sanitary plunger 100, substantially identical in structure and function to a conventional wooden-handled toilet plunger, is disclosed. Further, the toilet plunger may include a vertical, cylindrical handle, such as the handle 102 affixed with threads, such as the plurality of threads 508 at a lower end to a flexible plunger head, such as the plunger head 106. Further, the toilet plunger may include a screened check valve, such as the screened check valve 602 and small air vents, such as the at least one air vent 506 in the lower end of the handle near the plunger head to create a one-way flow for both air and water, and enable a user to easily build up suction and clear the toilet clog without creating large air bubbles in the toilet. Further, the user may use the toilet plunger in the same manner as a conventional toilet plunger.

Further, the handle may be manufactured from a rigid, durable material such as wood, plastic, or fiberglass. Further, the check valve may be manufactured from rigid, durable, and corrosion resistant materials, such as steel, brass, plastic, and aluminum alloy. Further, the plunger head may be manufactured from a flexible, durable material such as rubber.

Components, component sizes, and materials listed above are preferable, but artisans will recognize that alternate components and materials could be selected without altering the scope of the disclosure.

While the foregoing written description of the disclosure enables one of ordinary skill to make and use what may be presently considered to be the best mode thereof, those of ordinary skill in the art will understand and appreciate the existence of variations, combinations, and equivalents of the specific embodiment, method, and examples herein. The disclosure should, therefore, not be limited by the above described embodiment, method, and examples, but by all embodiments and methods within the scope and spirit of the disclosure.

Although the disclosure has been explained in relation to its preferred embodiment, it is to be understood that many other possible modifications and variations can be made without departing from the spirit and scope of the disclosure.

What is claimed is:

1. A sanitary plunger with a check valve, the sanitary plunger comprising:
a handle comprising an elongated cylindrical structure configured for handling the sanitary plunger, and manipulation of a plunger head, wherein the handle comprises:
a coupling mechanism at first end of the elongated cylindrical structure, wherein the coupling mechanism is configured for interfacing with the plunger head;
at least one air vent proximate to the first end configured to vent air pressure from the plunger head; and,
a check valve configured for allowing one directional flow of fluids from the plunger head to the handle; and,
the plunger head comprising a generally hemispherical shape, wherein the plunger head is configured for clearing clog build-up inside a drain channel, wherein the plunger head comprises a central elongation from a top end of the plunger head, wherein the central elongation comprises an opening configured for receiving the coupling mechanism of the handle.

2. The sanitary plunger of claim 1, wherein the check valve comprises at least one of a ball check valve, a diaphragm check valve, a spring check valve, a stop check valve, and a lift check valve.

3. The sanitary plunger of claim 1, wherein the check valve comprises a screened check valve.

4. The sanitary plunger of claim 1, wherein the check valve and the at least one air vent is configured for creating a one-way flow of fluids enabling build-up of pressure and suction for clearing the clog build-up inside the drain channel.

5. The sanitary plunger of claim 1, wherein the handle is manufactured from a rigid and durable material including at least one of wood, plastic, and fiberglass.

6. The sanitary plunger of claim 1, wherein the check valve is manufactured from a rigid, durable, and corrosion resistant material including at least one of steel, brass, plastic, and aluminum alloy.

7. The sanitary plunger of claim 1, wherein the plunger head is manufactured from a flexible and durable material including at least one of Polychloroprene, Styrene-Butadiene-Rubber, and Polychloroprene.

8. The sanitary plunger of claim 1, wherein the plunger head is resiliently collapsible, wherein a shape of the plunger head is configured to adapt based on a shape of the drain.

9. The sanitary plunger of claim 1, wherein the coupling mechanism comprises a plurality of threads configured for interfacing with the plunger head.

10. The sanitary plunger of claim 9, wherein the opening comprises a plurality of receiving threads configured for receiving the plurality of threads.

11. The sanitary plunger of claim 1, wherein the plunger head comprises a vent bore extending from an outer surface of the plunger head to an inner surface of the plunger head.

12. The sanitary plunger of claim 11 comprising a vent valve assembly disposed in the vent bore.

13. A sanitary plunger with a check valve, the sanitary plunger comprising:
a handle comprising an elongated cylindrical structure configured for handling the sanitary plunger, and manipulation of a plunger head, wherein the handle comprises:
a plurality of threads configured for interfacing with the plunger head at a first end of the elongated cylindrical structure;
at least one air vent proximate to the first end configured to vent air pressure from the handle; and,
a screened check valve configured for allowing one directional flow of fluids from the plunger head to the handle; and,
the plunger head comprising a generally hemispherical shape, wherein the plunger head is configured for clearing clog build-up inside a drain channel, wherein the plunger head comprises a central elongation from a top end of the plunger head, wherein the central elongation comprises an opening including a plurality of receiving threads configured for receiving the plurality of threads of the handle.

14. The sanitary plunger of claim 13, wherein the screened check valve comprises at least one of a ball check valve, a diaphragm check valve, a spring check valve, a stop check valve, and a lift check valve.

15. The sanitary plunger of claim 13, wherein the handle is manufactured from a rigid and durable material including at least one of wood, plastic, and fiberglass.

16. The sanitary plunger of claim 13, wherein the screened check valve is manufactured from a rigid, durable, and corrosion resistant material including at least one of steel, brass, plastic, and aluminum alloy.

17. The sanitary plunger of claim 13 wherein the plunger head is manufactured from a flexible and durable material including at least one of Polychloroprene, Styrene-Butadiene-Rubber, and Polychloroprene.

18. The sanitary plunger of claim 13, wherein the plunger head is resiliently collapsible, wherein a shape of the plunger head is configured to adapt based on a shape of the drain.

19. The sanitary plunger of claim 13, wherein the plunger head comprises a vent bore extending from an outer surface of the plunger head to an inner surface of the plunger head.

20. The sanitary plunger of claim 19 comprising a vent valve assembly disposed in the vent bore.
